(19) United States
(12) Patent Application Publication
(10) Pub. No.: US 2009/0096920 A1
(43) Pub. Date: Apr. 16, 2009

(54) METHOD AND SYSTEM FOR INTEGRATED MULTI-STANDARD TV AUDIO ENCODER

(76) Inventors: Fan Xu, Oceanside, CA (US); Devyani Sharma, Irvine, CA (US); Yovy Utama, Irvine, CA (US); Mark Taylor Core, Irvine, CA (US); Hosahalli Rajarao Srinivas, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/872,809

(22) Filed: Oct. 16, 2007

(51) Int. Cl. H04N 7/01

(52) U.S. Cl. 348/441; 348/E05.114; 348/E07.017; 348/720

(57) ABSTRACT

Aspects of a method and system for a multi-standard TV audio encoder are provided. In this regard, an integrated multistandard television audio encoder may be configured to encode television audio signals using a specified television audio standard. Moreover, once configured, the multistandard television audio encoder may encode television audio signals using the specified television audio standard. Exemplary television audio standards may comprise BTSC, A2, EIA-J, and NICAM. The multistandard television audio encoder may be enabled to generate all or portions of audio signals in accordance with one or more television audio standards. The multistandard television audio encoder may be enabled to generate baseband and/or RF modulated television audio signals. Accordingly, the multistandard television audio encoder may be enabled to generate an audio portion of a composite television signal. The multistandard television audio encoder may be programmably controlled via a processor and/or a control/programming interface.

### CROSS-REFERENCE TO RELATED APPLICATIONS/INCORPORATION BY REFERENCE

Not applicable

### FIELD OF THE INVENTION

Certain embodiments of the invention relate to audio signal processing. More specifically, certain embodiments of the invention relate to a method and system for a multi-standard TV audio encoder.

### BACKGROUND OF THE INVENTION

Conventional analog TV signals are defined primarily the National Television Standards Committee (NTSC), the Phase Alternative Line (PAL) or the Sequential Couleur Avec Memoire (SECAM) systems, and used in different countries around the world. An analog TV signal utilizes mainly two or three RF carriers, combined in the same channel band. One carrier may commonly be amplitude modulated (AM) with video content, and the other may be frequency modulated (FM) and/or amplitude modulated (AM) with audio content. An analog TV receiver functions by performing a series of operations comprising adjusting the signal power, separating the video and audio carriers, and locking to each carrier in order to down-convert the signals to baseband. The baseband video signal may then be decoded and displayed by achieving horizontal and vertical synchronization and extracting the luminance and color information. After demodulating the received signal, the resulting baseband audio may be decoded, and left, right, surround channels and/or other information may be extracted.

With the rapidly advancing technology surrounding television, TV network providers, such as cable and satellite providers, have been replacing or otherwise upgrading their transmission and distribution systems to provide new and/or better quality services to their viewers or paid subscribers. In addition to transmitting analog signals, the infrastructure of these upgraded or new systems are also adapted to facilitate the generation and transmission of various digital formats that provide superior picture and sound quality, higher channel capacity, high-speed Internet data services, voice services and/or interactive services. However, given the size of existing television infrastructure, television network providers must also provide support for legacy systems, and therefore, provide support for both analog and digital television systems.

In this regard, set-top boxes are becoming more popular as a means to provide more and higher quality services to customers, while remaining compatible with legacy televisions. Accordingly, a set-top box may receive a television signal, extract the video, audio, and other information comprising the television signal, and then encode the information onto a legacy analog television signal. The analog signal may then be transmitted to a television via, for example, a coaxial cable or composite video cable. However, although analog television signals are supported to a large extent by most televisions, there may still be compatibility issues due to the different analog television formats and standards used throughout the world.

A conventional television set-top box is used to receive signals from a source (such as cable, a satellite, or off-the-air transmission system) and to decode these signals. The decoded signals represent audio and video which are output through connectors to a television set. To maintain compatibility with older televisions (as well as for a variety of other reasons) set-top boxes often provide an RF output such that received television signals are re-encoded to an analog television standard, modulated onto an RF carrier, and output via a coaxial or composite video cable.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a multi-standard TV audio encoder, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a frequency spectrum of an exemplary composite TV signal comprising a BTSC encoded audio channel, in connection with an embodiment of the invention.

FIG. 1b is a frequency spectrum of an exemplary composite TV signal comprising an A2 encoded audio channel, in connection with an embodiment of the invention.

FIG. 1c is a frequency spectrum of an exemplary composite TV signal comprising a NICAM encoded audio channel, in connection with an embodiment of the invention.

FIG. 1d is a frequency spectrum of an exemplary composite TV signal comprising an EIA-J encoded audio channel, in connection with an embodiment of the invention.

FIG. 2 is a block diagram illustrating exemplary functions of a television set-top box, in accordance with an embodiment of the invention.

FIG. 3 is a block diagram of an exemplary RF modulator, which may be configured to support multiple television audio standards, in accordance with an embodiment of the invention.

FIG. 4 is a block diagram of an exemplary digital audio processor configurable to support multiple encoding standards, in accordance with an embodiment of the invention.

FIG. 5 is a block diagram of an exemplary multi-standard audio encoding block configured for BTSC encoding, in accordance with an embodiment of the invention.

FIG. 6 is a block diagram of an exemplary multi-standard audio encoding block configured for A2 stereo encoding, in accordance with an embodiment of the invention.

FIG. 7 is a block diagram of an exemplary multi-standard audio encoding block configured for EIA-J encoding, in accordance with an embodiment of the invention.

FIG. 8 is a block diagram of an exemplary multi-standard audio encoding block configured for NICAM encoding, in accordance with an embodiment of the invention.

### DETAILED DESCRIPTION OF THE INVENTION

Certain embodiments of the invention may be found in a method and system for a multi-standard TV audio encoder. In this regard, an integrated multistandard television audio encoder may be configured to encode television audio signals using a specified television audio standard. Moreover, once configured, the multistandard television audio encoder may encode television audio signals using the specified television audio standard. Exemplary television audio standards may comprise BTSC, A2, EIA-J, and NICAM. The multistandard television audio may be enabled to generate all or portions of audio signals in accordance with one or more television audio standards. The multistandard television audio encoder may be enabled to generate baseband and/or RF modulated television audio signals. Accordingly, the multistandard television audio encoder may be enabled to generate an audio portion of a composite television signal. The multistandard television audio encoder may be programmably controlled via a processor and/or a control/programming interface. Configuration of the multistandard television audio encoder may comprise configuring one or more filters to perform preemphasis filtering in accordance with one or more television audio standard. Configuration of the multistandard television audio encoder may comprise configuring one or more modulators to perform amplitude and/or frequency modulation of subcarriers in accordance with one or more television audio standards. Configuration of the multistandard television audio encoder may comprise configuring one or more sample rate converters to upsample or downsample television audio signals. Aspects of the invention may enable generating one or more pilot and/or identification signals in accordance with one or more television audio standards.

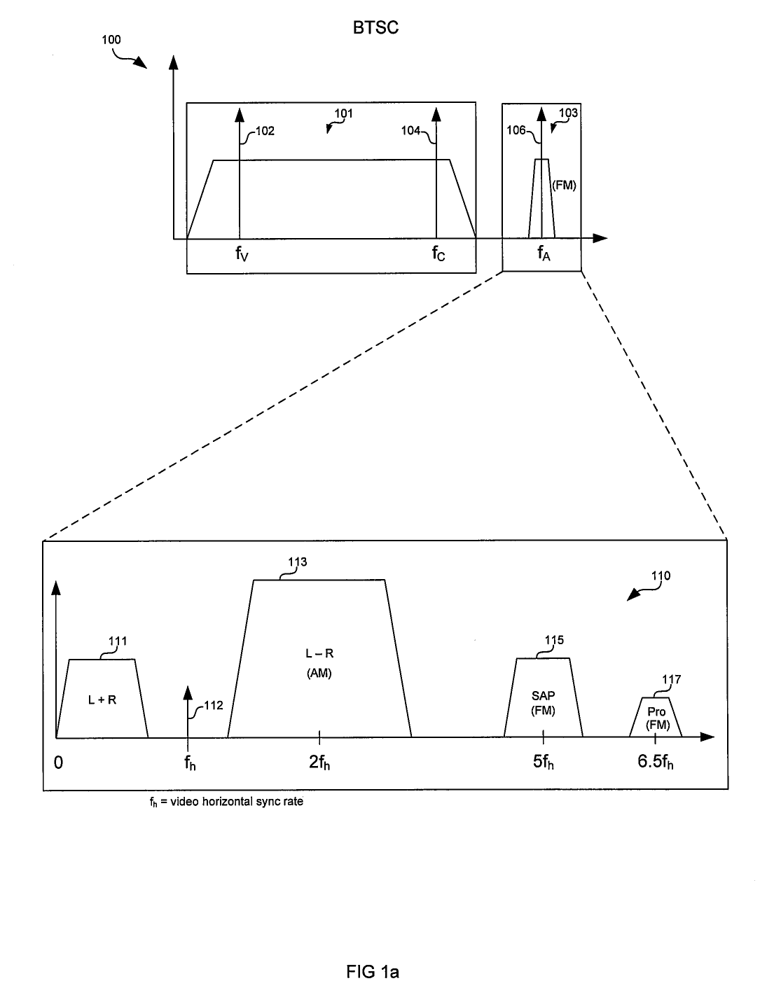

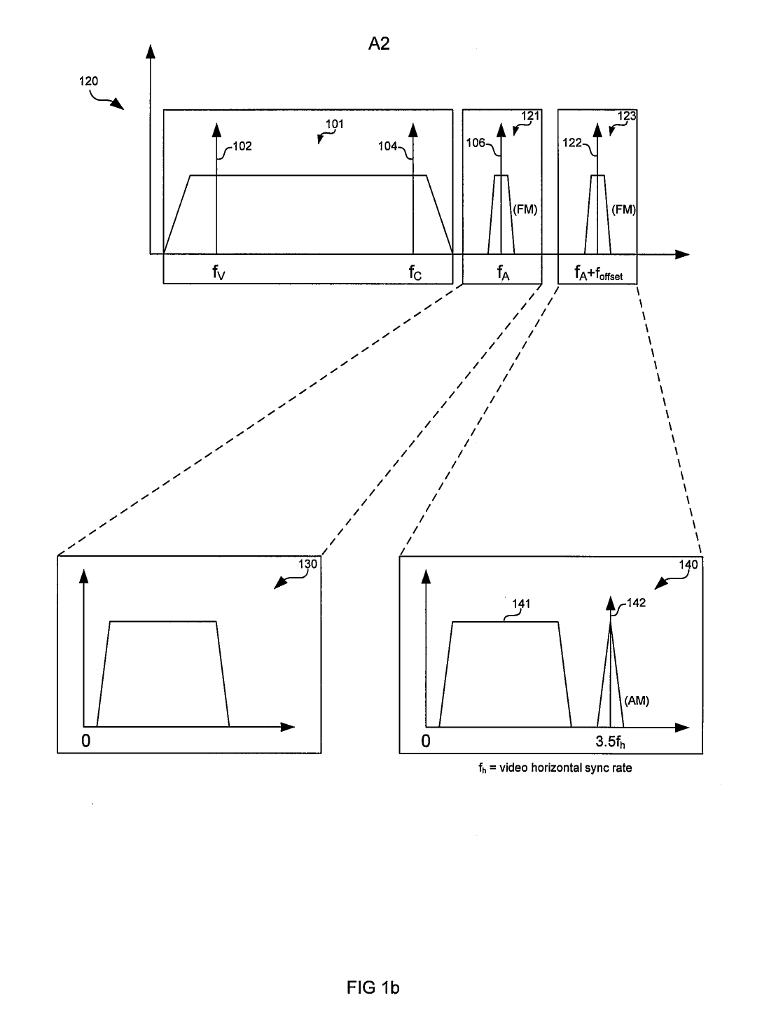

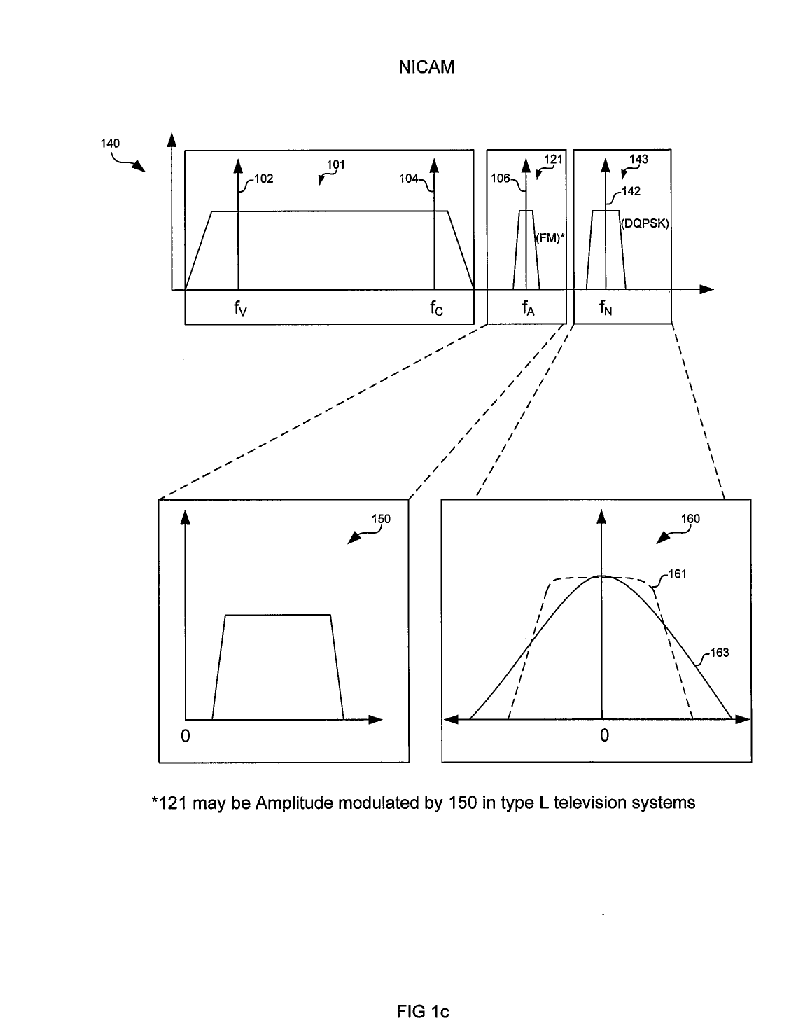

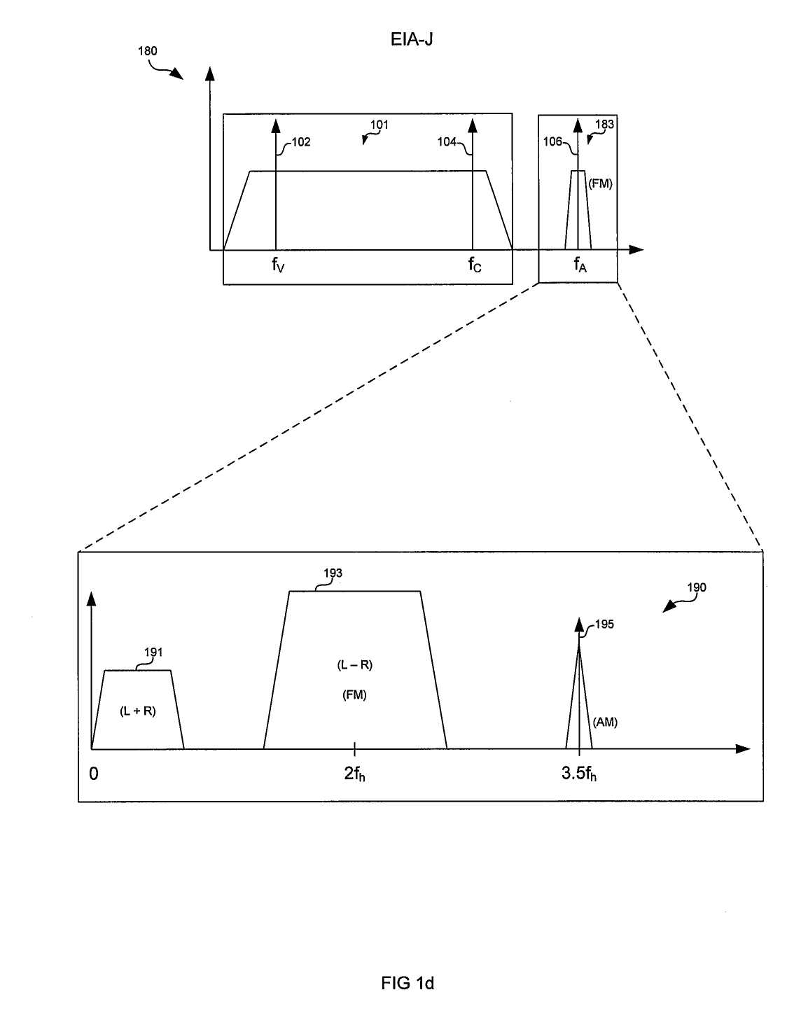

A variety of standards may be utilized to define the type and format of the audio portion of a television channel. In this regard, the format of the audio portion of a television channel may vary depending on the country in which the television channel is being broadcast. Four of the most common audio standards used throughout the world are BTSC (named for the Broadcast Televisions Systems Committee that defined the standard, also referred to as multichannel television sound (MTS)), EIA-J (Electronics Industries Association of Japan) stereo, A2 stereo (often referred to as ‘Zweikanalton’ or ‘German Stereo’), and Near Instantaneous Companded Audio Multiplex (NICAM). FIG. 1a is a frequency spectrum of an exemplary composite TV signal comprising a BTSC encoded audio channel, in connection with an embodiment of the invention. Referring to FIG. 1a, the spectrum 100 comprises video channel 101 and an audio channel 103. The video channel may further comprise a video carrier 102, which may be amplitude modulated by luminance information and a color carrier 104, which may be frequency modulated or quadrature amplitude modulated by chrominance information. The audio channel 103 may further comprise an audio carrier 106 frequency modulated by the BTSC composite 110. The BTSC composite 110 may comprise an L+R channel 111, a pilot tone 112, an L−R channel 113, a SAP channel 115, and a professional channel 117.

The pilot tone 112 may be a continuous wave signal with a frequency equal to the video horizontal scan frequency, fₕ. In an exemplary embodiment of the invention, fₕ may be 15.734 kHz. The pilot tone 112 may be transmitted as part of the BTSC composite to enable a receiver to detect that the audio channel is BTSC encoded and/or to indicate that a stereo and/or SAP channel is available. Additionally, the pilot tone 112 may be utilized to demodulate the L−R channel in instances where the L−R channel is double sideband suppressed carrier (DSBSC) amplitude modulated.

The sum (L+R) channel 111 may be generated by the addition of left and right audio channels in a stereophonic system. The sum channel 111 may be utilized by some receivers to output monophonic audio. In this regard, the BTSC composite 110 may maintain compatibility with older monophonic audio standards.

The difference (L−R) channel 113 may be generated by first subtracting a right audio channel from left audio channel in a stereophonic system and then amplitude modulating a carrier of frequency 2 fₕ. The difference channel 113 may be utilized by a stereophonic receiver to recover left and right audio channels. In this regard, the sum and difference channels may be added to recover a left audio channel, and the difference channel may be subtracted from the sum channel to recover a right audio channel.

The SAP channel 115 may, for example, be utilized to transmit audio in an alternate language. The SAP channel 115 may be generated by frequency modulating a carrier at 5 fₕ by a monophonic audio signal.

The professional channel 117 modulates an RF carrier at 6.5 fₕ and is normally used only by broadcast professionals and may carry data and/or audio.

FIG. 1b is a frequency spectrum of an exemplary composite TV signal comprising A2 stereo encoded audio, in connection with an embodiment of the invention. Referring to FIG. 1b, the spectrum 120 comprises video channel 101 and audio channels 121 and 123. The video channel may further comprise a video carrier 102, which may be amplitude modulated by luminance information and a color carrier 104, which may be frequency modulated or quadrature amplitude modulated by chrominance information. The first audio channel 121 may further comprise an audio carrier 106 frequency modulated by a baseband audio signal 130. The format/composition of the first audio channel 121 may vary based on the transmission mode, as depicted in Table 1. The second audio channel 123 may further comprise an audio carrier 122 frequency modulated by a composite signal 140.

The composite audio signal 140 may comprise a baseband audio signal 141 and a pilot 142 located at a frequency of 3.5 fₕ. In this regard, an exemplary value of fₕ may be 15625 kHz. The pilot 142 may be modulated by a low frequency signal and may be utilized to indicate the transmission mode to a receiver. The format/composition of the second audio channel 123 may vary based on the transmission mode as depicted in Table 1.

TABLE 1
Channel Format/Composition for Various A2 Stereo Modes

| | | 2^{nd} Audio |
|---|---|---|
| Mode | 1^{st} Audio Channel | Channel |
| mono | L + R | Off (no carrier) |
| Stereo (PAL) | L + R | R |
| Dual sound | Mono signal 1 | Mono signal 2 |
| Stereo (Korean-NTSC) | L + R | L − R** |

Table 1 Key:
L = left audio signal in a stereo audio pair.
R = right audio signal in a stereo audio pair.
L + R = sum signal resulting from the addition of the left audio signal and the right audio signal in a stereo audio pair of signals.
L − R = sum signal resulting from the addition of the left audio signal and the right audio signal in a stereo audio pair of signals.
Mono signal 1 = First mono signal in dual mono signal transmission.
Mono signal 2 = Second mono signal in dual mono signal transmission.

FIG. 1c is a frequency spectrum of an exemplary composite TV signal comprising a NICAM encoded audio channel, in connection with an embodiment of the invention. Referring to FIG. 1c, the spectrum 140 comprises video channel 101 and audio channels 121 and 143. The video channel may further comprise a video carrier 102, which may be amplitude modulated by luminance information and a color carrier 104, which may be frequency modulated or quadrature amplitude modulated by chrominance information. The first audio channel 121 may further comprise an audio carrier 106 frequency modulated by a baseband audio signal 150. The second audio channel 143 may comprise a carrier 142, which may be modulated by a digital audio bitstream using digital quadrature phase shift keying (DQPSK). In various television systems (system L), the NICAM signal may be band limited to approximately 700 kHz at the −30 dB point resulting in the spectrum 161. In other various television systems (system B/G), the NICAM signal may be band limited to approximately 500 kHz at the −30 dB point resulting in the spectrum 163. In the SECAM L standard, the audio channel 121 may be amplitude modulated while the audio channel 143 may be DQPSK modulated. In this regard, the carrier 106 may be amplitude modulated by the baseband audio signal 150 while the carrier 142 may be DPQSK modulated by a digital audio bitstream.

FIG. 1d is a frequency spectrum of an exemplary composite TV signal comprising an EIA-J encoded audio channel, in connection with an embodiment of the invention. Referring to FIG. 1d, the spectrum 180 may comprise a video channel 101 and an audio channel 183. The video channel may further comprise a video carrier 102 amplitude modulated by luminance information and a color carrier 104 frequency modulated or quadrature amplitude modulated by chrominance information. The audio channel 183 may further comprise an audio carrier 106 frequency modulated by an EIA-J composite 190. The EIA-J composite 190 may comprise an L+R channel 191, an L−R channel 193, and a pilot tone 195 located at a frequency of 3.5 fₕ. The pilot tone 195 may be amplitude modulated by a low frequency signal and may be utilized to indicate the transmission mode to a receiver.

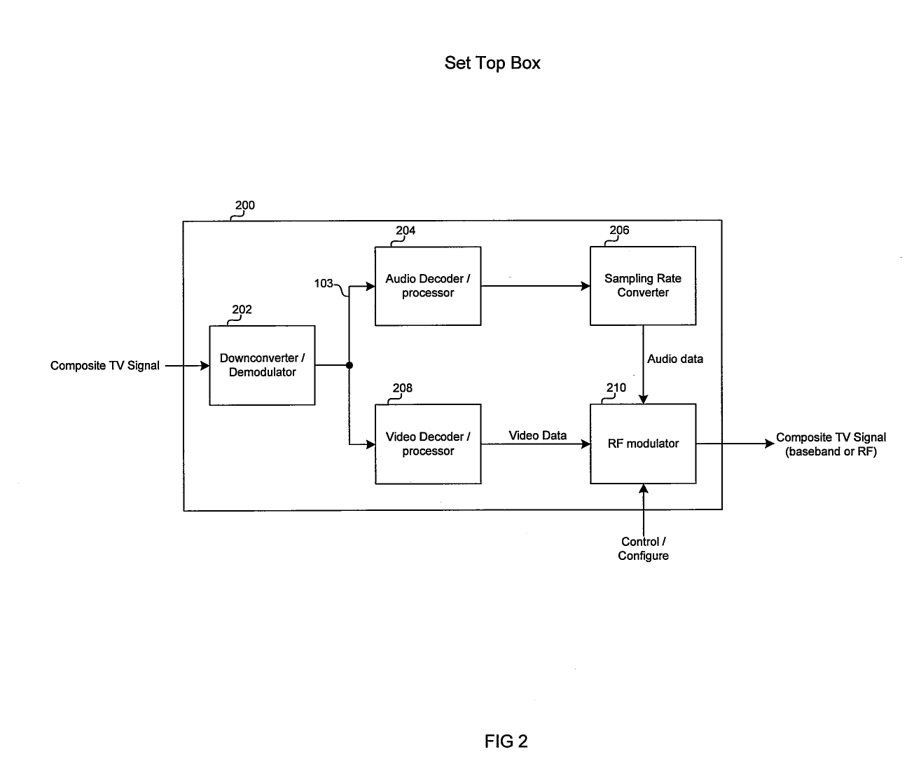

FIG. 2 is a block diagram illustrating exemplary functions of a television set-top box, in accordance with an embodiment of the invention. Referring to FIG. 2, the set-top box 200 may comprise a down-converter/demodulator 202, an audio decoder/processor 204, a sampling rate converter 206, a video decoder/processor 208, and a RF modulator 210.

The down-converter/demodulator 202 may comprise suitable logic, circuitry, and/or code that may enable receiving television signals from a cable, satellite, or over-the-air transmission and output of baseband audio and/or video signals. The digital audio may be output as two pulse code modulated (PCM) bitstreams comprising left and right audio channels, respectively. In an exemplary embodiment of the invention, the digital audio may be output at a sample rate of 27 MHz/85.5.

The audio decoder/processor 204 may comprise suitable logic, circuitry, and/or code that may enable filtering, equalization, de-emphasis, expansion, or otherwise decoding/processing one or more channels of baseband PCM audio channels. In this regard, the audio decoder/processor 204 may, for example, perform the reverse of operations performed at a transmitter in order to compensate for transmission channel effects etc. For example, in a BTSC system the audio decoder/processor 204 may perform de-emphasis, wideband expansion, and/or spectral expansion per the BTSC standard.

The sample rate converter 206 may comprise suitable logic, circuitry, and/or code that may enable conversion of digital audio streams of a first sampling frequency to digital audio streams of a different sampling frequency. In an exemplary embodiment, the sample rate converter 106 may up-sample digital audio from 32 kHz, 44.1 kHz, 48 kHz, or 96 kHz to 27 MHz/32 (or, 843.75 kHz).

The video decoder/processor 208 may comprise suitable logic, circuitry, and/or code that may enable extracting video content from a received RF signal and output a digital video stream. The video decoder/processor 208 may additionally output a signal utilized to synchronize other components of the set-top box 200 to the received video content. For example, the video decoder/processor 208 may output a signal synchronized to the start of each video frame or synchronized to video line rate (horizontal synch).

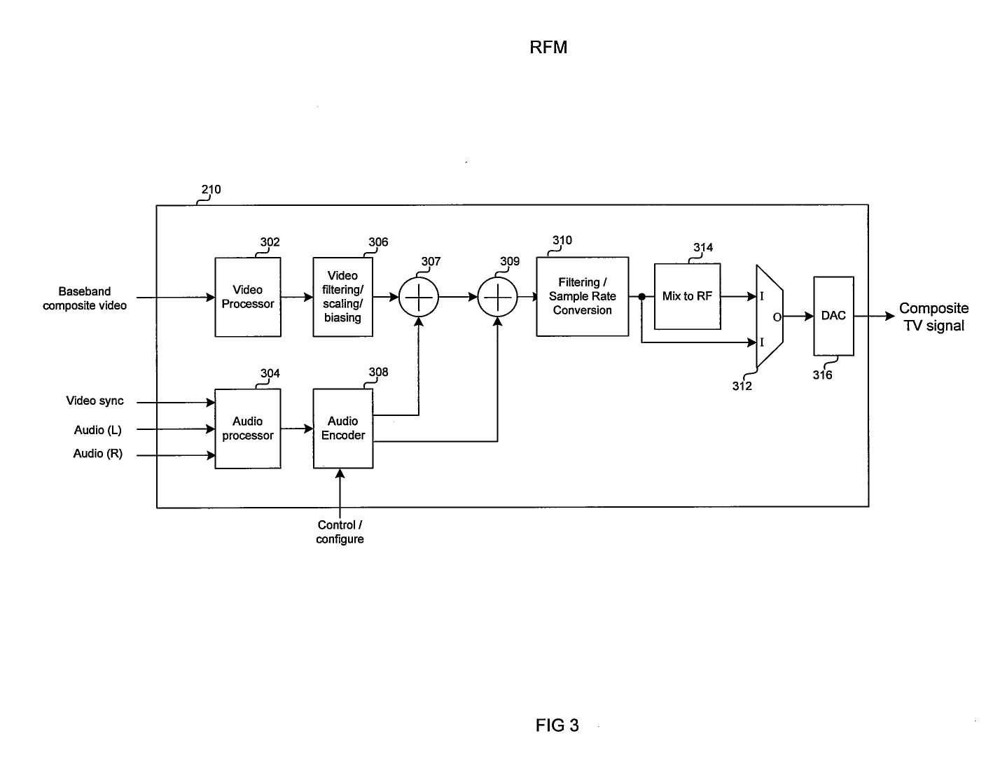

The RF modulator (RFM) 210 may comprise suitable logic, circuitry, and/or code that may enable receiving digital audio and/or video, encoding the audio and/or video according to one or more television standards, and modulating an RF carrier to generate a composite television signal as described in FIG. 1a, 1b, 1c, or 1d. The resulting RF signal may then be transmitted, for example, via a coaxial cable, to an off-the-shelf television or other display device capable of decoding one or more of the composite television signals described with regards to FIGS. 1a, 1b, 1c and/or 1d. The RFM 210 may be compatible with a number of television standards. Accordingly, the RFM 210 may be configured to operate in a mode that is selected from a plurality of video and/or audio standards in order to generate the composite television signal. In this regard, the RF modulator 210 may be configured, for example, via software and/or firmware to operate in BTSC, A2, EIA-J, and/or NICAM television audio standards. Additional details of the RFM 210 are described herein in FIG. 3.

In operation, the set-top box 200 of FIG. 2 may receive a composite television signal. For example, the composite television signal may be received via a coaxial cable connected to an antenna enabled to receive over-the-air transmissions. Subsequently, the composite television signal may be downconverted and/or demodulated to extract audio and video components of the television signal. The video component may be decoded and/or processed to extract luminance and chrominance information. The audio component may be decoded and/or processed to extract monophonic, stereophonic, SAP, and/or professional audio channels. The extracted audio and/or video may be upsampled or downsampled and may be passed to the RFM block 210. The RFM 210 may encode the audio and/or video according to one or more standards, modulate the audio and/or video onto an RF carrier to generate a composite television signal, and transmit the composite television signal to a television or similar display device. In this manner, the configurable RFM 210 may, for example, provide compatibility between legacy televisions and emerging and/or evolving television technologies such as digital cable and satellite. Moreover, the configurable nature of the RFM 210 may enable the set-top box 200 to be utilized in a variety of regions which employ different standards. Additional details of the RFM 210 are described herein in FIG. 3.

FIG. 3 is a block diagram of an exemplary RF modulator, which may be configured to support multiple television audio and video standards, in accordance with an embodiment of the invention. Referring to FIG. 3, the RFM 210 may comprise a digital video processor 302, a digital audio processor 304, a video encoder 306, an audio encoder 308, a filtering and/or sample-rate-conversion block 310, a switching element 312, a mixer 314, and a digital-to-analog converter (DAC) 316.

The digital video processor 302 may comprise suitable logic, circuitry, and/or code that may enable altering a sample rate of an input digital video stream and performing audio trap filtering and group-delay pre-correction according to video standard(s) for which the processor 302 is designed to operate in.

The digital video filtering/scaling/biasing 306 may comprise suitable logic, circuitry, and/or code that may enable encoding video signals according to NTSC, PAL, and/or SECAM standards. In this regard, the digital video filtering/scaling/biasing block 306 may be configured via software and/or firmware to scale video signals to a correct levels, add DC bias to video signals, and optionally invert video signals to comply with a selected video standard. In one embodiment of the invention, the digital video filtering/scaling/biasing block 306 may comprise a register set programmable via downloadable code from a memory device comprising the set-top box 300.

The digital audio processor 304 may comprise suitable logic, circuitry, and/or code that may enable sampling rate conversion, filtering, and volume adjustment of baseband audio signals. The digital audio processor 304 may receive and use a video synchronizing signal to synchronize generated pilot and carrier tones to a horizontal video line rate.

The digital audio encoder 308 may comprise suitable logic, circuitry, and/or code that may enable encoding audio according to BTSC, A2, EIA-J, and/or NICAM standards. In this regard, the encoding standard utilized by the digital audio encoder 308 may be configured, via software, firmware, and/or hardware. In one embodiment of the invention, the digital audio encoder 308 may comprise a register set programmable via downloadable code from a memory device comprising the set-top box 300. In various embodiments of the invention, the digital audio encoder 308 may be configured to produce one or two sets of encoded audio signals. These encoded audio signals may comply with one or more audio standards that the digital audio encoder 308 may be configured to operate in via register configuration or code selection. The encoded audio signals may be combined with encoded video output by the video filtering/scaling/biasing block 306 using the two adders 307 and 309. Depending upon the audio standard the encoder 308 is programmed to operate in, either one output or both outputs from the encoder 308 may comprise encoded audio. In an exemplary instance where only one output comprises encoded audio, as per a particular standard, the second output may not comprise encoded audio but may instead be a zero valued signal. The adder 309 may produce as its output a composite baseband TV signal. The baseband composite output may be communicatively coupled to the Filtering/Sample rate conversion block 310

The filtering or sample-rate-conversion block 310 may comprise suitable logic, circuitry, and/or code that may enable filtering and/or changing the sample rate of a composite television signal. In this regard, the filtering functions of the filtering or sample-rate-conversion block 310 may enable reducing unwanted signals and enhancing desirable signals in a composite television signal. The sample rate conversion function of the filtering and/or sample-rate-conversion block 310 may enable conditioning the digital composite television signal such that the RFM 210 output may be compatible with a variety of devices and/or standards. For example, the filtering and/or sample-rate-conversion block 310 may enable the RF modulator to output signals which may be compatible with PAL, NTSC, and/or SECAM television standards.

The switching element 312 may comprise suitable logic, circuitry, and/or code that may enable routing a composite television signal through the RFM 210. In this regard, one or more control signals provided to the switching element 312 may enable routing the composite television signal via the mixer 314 or around the mixer 314. Bypassing the mixer 314 may enable the RFM 210 to output a baseband composite television signal.

The mixer 314 may comprise suitable logic, circuitry, and/or code that may transmit a baseband composite TV signal centered at a frequency which may be much higher than DC. In this manner, the mixer 314 may enable conversion of a baseband television signal to an RF composite television signal suitable for transmission. In this regard, the television signal may be transmitted at any frequency desired for a given application. For example, in a set-top box intended for use in the United States, in one embodiment of the invention, the mixer 314 may up-convert the baseband signal to “channel 3”, or 60-66 MHz. In various embodiments of the invention, the frequency output by the mixer 314 may be selectable. For example, in a set-top box intended for use in the United States the frequency may be selected as “channel 3” or “channel 4”.

The DAC 316 may comprise suitable logic, circuitry, and/or code that may enable converting digital signals to analog signals. In this regard, the DAC 316 may be enabled to convert a digital composite television signal to an analog composite television signal.

In operation, the RFM 210 of FIG. 3 may receive a baseband digital video signal and its accompanying baseband digital audio signal. The digital video processor 302 may perform any necessary sample rate conversion or desired manipulations of the video. In this regard, the RFM 210 may be programmably controlled to determine what operations are performed on the video signal. The digital video filtering/scaling/biasing block 306 may be configured via software, firmware and/or hardware to scale video signals to a correct level, add DC bias to video signals, and optionally invert video signals to comply with a selected video standard such as NTSC, PAL, or SECAM standards. The digital audio processor 304 may perform any necessary or desired manipulations of the audio. In this regard, the RFM 210 may be programmably controlled to determine what operations are performed on the audio signal. The digital audio processor 308 may generate the audio portion of a television signal by encoding the audio according to BTSC, A2, EIA-J, or NICAM standards. Accordingly, the operations performed on the audio may be based at least on part on the standard utilized to encode the audio.

The baseband video and audio signals output by the digital video filtering/scaling/biasing block 306 and the digital audio encoder 308 may be combined to generate a baseband composite television signal. In this regard, the output(s) of the digital video filtering/scaling/biasing block 306 and the digital audio encoder 308 may be combined utilizing the two summers 307 and 309. Additionally, the output(s) of the digital video filtering/scaling/biasing block 306 and the digital audio encoder 308 may be scaled to correct levels to comply with one or more video and/or audio television transmission standards. The baseband composite television signal may be filtered and/or up-sampled or down-sampled depending on the desired sample rate of the RFM 210 output. In this regard, the RFM 210 may be programmably controlled to adjust for different input and/or output sample rates associated with different audio and video standards. The switch 312 may then select either the output of the filtering or sample-rate-conversion block 310 or the output of the mixer 314 for routing to the DAC 316. In this regard, the switch 312 may receive one or more control signals which may determine the routing of the digital baseband composite television signal.

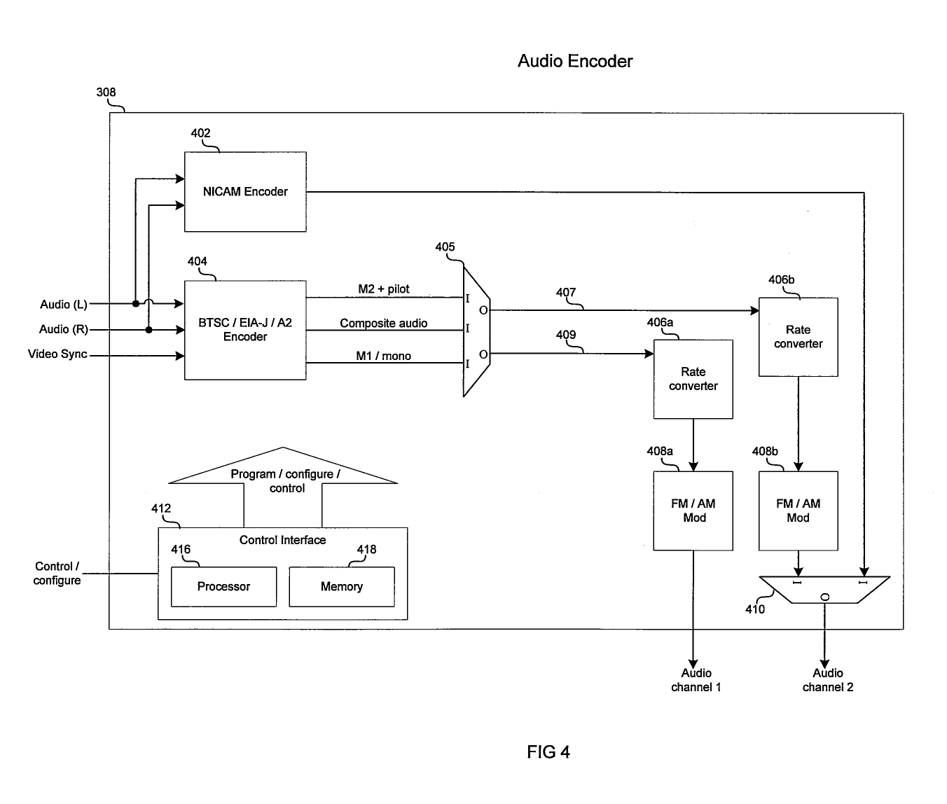

FIG. 4 is a block diagram of an exemplary digital audio processor configurable to support multiple encoding standards, in accordance with an embodiment of the invention. Referring to FIG. 4 the audio encoder 308 may comprise a NICAM encoding block 402, a multi-standard encoding block 404, sample rate converters 406a and 406b, modulators 408a and 408b, switching element 410, and a control interface 412.

The NICAM encoding block 402 may comprise suitable logic, circuitry, and/or code that may enable encoding audio according to NICAM standards. In this regard, the NICAM encoding block 402 may process left and/or right baseband PCM audio signals to output an audio spectrum such as 161 or 163 as depicted in FIG. 1c. Accordingly, the NICAM encoding block 402 may perform DQPSK modulation of a carrier of frequency f_{N} to generate the audio channel 143 of FIG. 1c. Additionally, the NICAM encoding block may be enabled to perform packet generation and framing as per NICAM standards. In an exemplary embodiment of the invention, f_{N} may be equal to 6.552 MHz.

The multi-standard encoding block 404 may comprise suitable logic, circuitry, and/or code that may enable encoding audio according to monaural, BTSC, A2, and/or EIA-J standards. In this regard, the multi-standard encoding block 404 may process left and/or right baseband PCM audio channels to output all or a portion of the audio spectrums depicted in FIGS. 1a, 1b, 1c, and/or 1d. Furthermore, the multi-standard encoding block 404 may be enabled to perform signal processing and/or conditioning according to the various standards. For example, the multi-standard encoding block 404 may be enabled to perform filtering, pre-emphasis, amplitude compression, spectral compression, pilot signal generation and insertion, and scaling of audio signals.

The output of the multi-standard encoding block 404 may vary according to the encoding standard being utilized. For BTSC the multi-standard encoder 404 may output all or a portion of the BTSC composite 110 of FIG. 1a. In this regard, the multi-standard encoding block 404 may output a spectrum comprising one or more of the sum channel, the difference channel, the SAP channel, and the professional audio channel. For A2 the multi-standard encoding block 404 may output A1 and A2+pilot. In this regard, A1 may be the baseband audio signal 130 of FIG. 1b and A2+ pilot may be the composite audio signal 140 of FIG. 1b. For NICAM, the multi-standard encoding block 404 may output the monoaural audio signal 150 of FIG. 1c, and the NICAM encoding block 402 may output the audio signal 160 of FIG. 1c. For EIA-J the multi-standard encoding block 404 may output the composite signal 190 of FIG. 1d.

The switching element 405 may comprise suitable logic, circuitry, and/or code that may enable routing one or more outputs of the multi-standard encoding block 404 to the sample rate converters 406a and 406b. In this regard, one or more control signals provided to the switching element 405 may configure the routing of switch inputs, I, to switch outputs, O. When configured for BTSC encoding, the switching element 405 may route a BTSC composite audio signal to the sample rate converter 406a. When configured for A2 encoding, the switching element 405 may route a first audio channel, M1, to the sample rate converter 406a and route a second audio channel, M2+ pilot, to the sample rate converter 406b. When configured for NICAM, the switching element 405 may route a monaural signal to the sample rate converter 406a. When configured for EIA-J, the switching element 405 may route the composite audio signal to the sample rate converter 406a.

The sample rate converters 406a and 406b may comprise suitable logic, circuitry, and/or code that may enable up-sampling and/or down-sampling digital audio signals. In this regard, sample rate conversion may enable the audio encoder 308 to interface to a variety of other systems/circuits.

The modulators 408a and 408b may comprise suitable logic, circuitry, and/or code that may enable modulating an audio carrier by a digital audio signal. When configured for BTSC encoding, the modulator 408a may frequency modulate the BTSC composite signal onto a carrier at f_{A}, as shown in FIG. 1a. When configured for A2 encoding, the modulator 408a may frequency modulate the first audio channel, M1, onto a carrier at f_{A}, and the modulator 408b may frequency modulate the second audio channel, M2+ pilot, onto a carrier at f_{A}+f_{offset}. In an exemplary embodiment of the invention, f_{offset} may be equal to 242 kHz. When configured for NICAM encoding, the modulator 408a may frequency modulate or amplitude modulate a mono signal onto a carrier at f_{A}, as shown in FIG. 1c. In this regard, amplitude modulation may be used in ‘L’ television systems, while frequency modulation may be utilized for other systems. When configured for EIA-J encoding, the modulator 408a may modulate a composite audio signal 190 onto a carrier at f_{A}, as shown in FIG. 1d. In various embodiments of the invention, the audio encoder 308 may be configured such that the outputs of the rate converters 406a and/or 406b may bypass the modulators 408a and/or 408b. In this regard, bypassing the modulators 408a and 408b, in addition to bypassing the mixer 314 as discussed in FIG. 3, may enable generation of a baseband television audio encoded signal.

The switching element 410 may comprise suitable logic, circuitry, and/or code that may enable selecting the source of a second audio channel. In this regard, one or more control signals provided to the switching element 410 may configure the routing of switch inputs, I, to switch outputs, O. When configured for NICAM, the switch 410 may select the output of the NICAM encoder 402. When configured for A2, the switch 410 may select the output of the modulator 408b. When configured for BTSC or EIA-J, the switch 410 may disable its output.

The control interface 412 may comprise suitable logic, circuitry, and/or code that may enable configuring, programming, controlling, or otherwise governing the operations of the audio encoder 308. The control interface 412 may comprise a processor 416 and a memory 418. The processor 416 may comprise suitable logic, circuitry, and/or code that may enable providing control signals to the blocks comprising the audio encoder 308. The memory 418 may comprise suitable logic, circuitry, and/or code that may enable storing control and/or configuration data. In various embodiments of the invention, the control interface 308 may enable configuring the audio encoder 308 via software and/or firmware. In various embodiments of the invention, the control interface 308 may provide a programming interface via which an external system may program, control, or reconfigure the audio encoder 308.

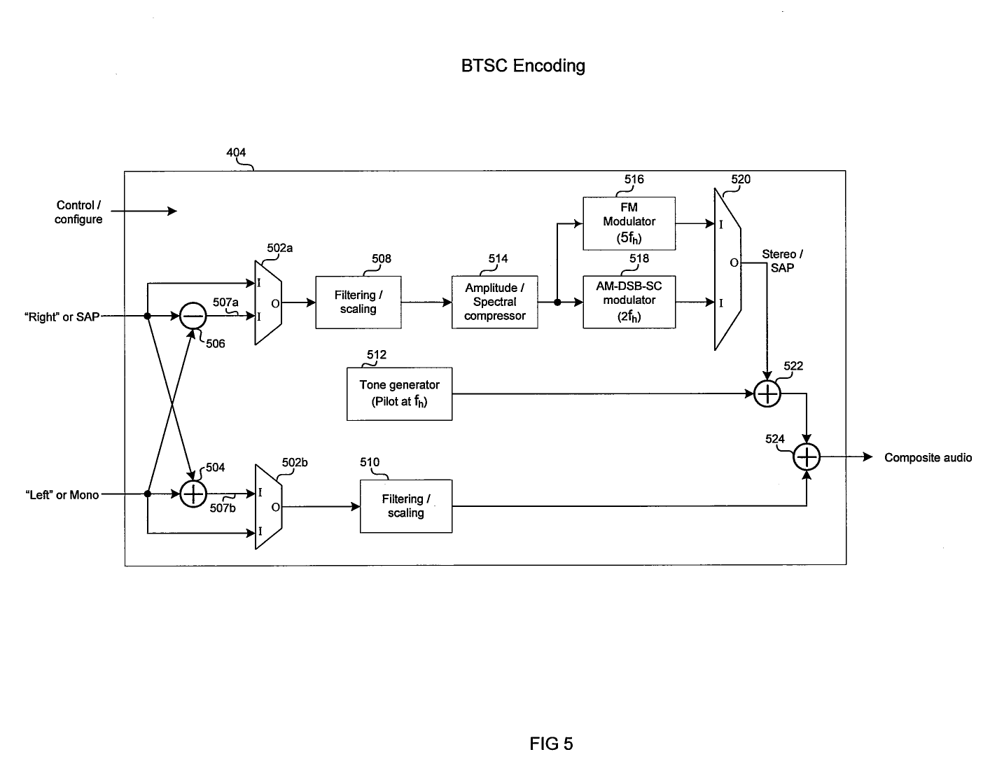

FIG. 5 is a block diagram of an exemplary multi-standard audio encoding block configured for BTSC encoding, in accordance with an embodiment of the invention. Referring to FIG. 5 the multi-standard encoding block may comprise adders 504, 522, and 524, subtractor 506, switching elements 502 and 520, filtering and/or scaling blocks 508 and 510, pilot tone generator 512, amplitude and/or spectral compressor 514, frequency modulator 516, and amplitude modulator 518.

The adders 504, 522, and 524 may comprise suitable logic, circuitry, and/or code for generating a signal corresponding to the addition of two digital audio signals. The subtractor 506 may comprise suitable logic, circuitry, and/or code for generating a signal corresponding to a difference between two digital audio signals.

The switching elements 502 and 520 may comprise suitable logic circuitry and/or code that may enable routing digital audio signals. In this regard, one or more control signals provided to the switching elements 502 and 520 may configure the routing of switch inputs, I, to switch outputs, O.

The filtering and/or scaling blocks 508 and 510 may comprise suitable logic, circuitry, and/or code that may enable conditioning digital audio signals. The filtering and/or scaling blocks 508 and 510 may be configurable via one or more control signals. In this regard, the audio signals may be conditioned according to the various encoding standards. For example, when configured for BTSC encoding, the filtering blocks 508 may be configured for BTSC difference channel fixed preemphasis from 50-15000 Hz and the filtering block 510 may be configured for 75 us preemphasis. The amplitude and/or spectral compressor 514 may comprise suitable logic, circuitry, and/or code that may enable conditioning digital audio signals. In this regard, the amplitude and/or spectral compression of audio signals may be performed according to BTSC standards. Amplitude and/or spectral compression may involve one or more feedback systems. Additional details may be found in applicable standards documents. In another example, when configured for A2 stereo, the filtering and/or scaling blocks 508 and 510 may be configured for 50 us preemphasis (75 us for Korean TV) and to scale the audio channels according to the standards. When configured for EIA-J stereo, the filtering and/or scaling blocks 508 and 510 may each perform preemphasis and/or scaling according to EIA-J standards. Additional information regarding appropriate signal conditioning for the various standards may be found in the applicable standards documents and is hereby incorporated herein by reference.

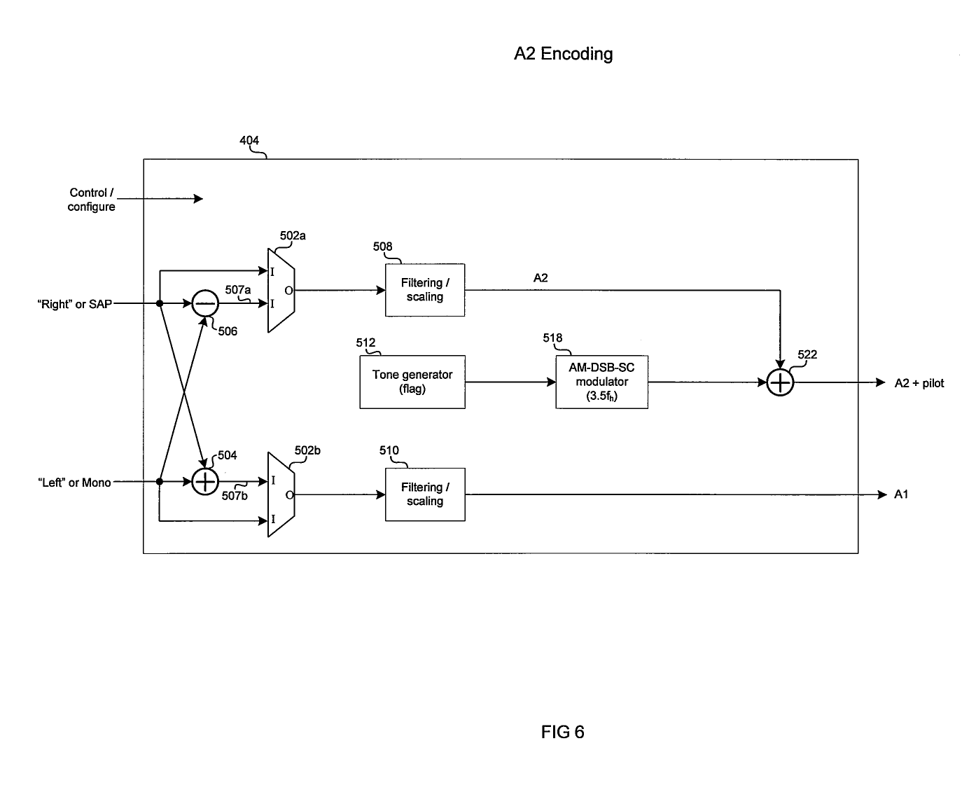

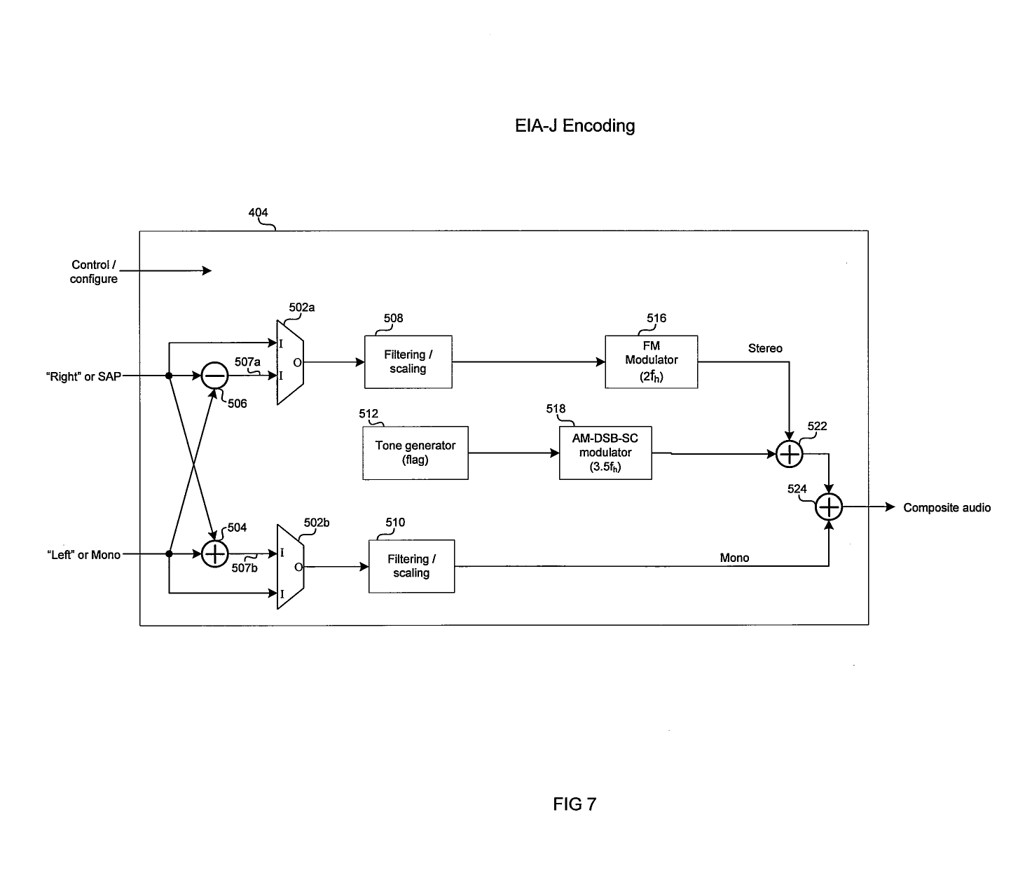

The tone generator 512 may comprise suitable logic, circuitry, and/or code that may enable generating tones per BTSC, A2 stereo, NICAM, and/or EIA-J standards. The pilot tone generator 512 may be configurable via one or more control signals. When configured for BTSC encoding, the tone generator 512 may be enabled to generate a pilot signal synchronized to a video line rate (fₕ). When configured for A2 encoding, as in FIG. 6, or EIA-J stereo encoding, as in FIG. 7, the tone generator 512 may generate a flag tone which may amplitude modulate a carrier of frequency 3.5 fₕ. In this regard, the amplitude modulator 518 may modulate the pilot tone onto a carrier tone of frequency 3.5 fₕ to generate an identification signal according to A2 and/or EIA-J stereo standards.

The Frequency modulator 516 may comprise suitable logic circuitry, and/or code for frequency modulating a carrier tone by a digital audio signal. The Frequency modulator 516 may be configured via one or more control signals to control, for example, carrier frequency and modulation depth. The frequency modulator 516 may enable impressing information onto a subcarrier for transmission as part of a multiplexed or composite audio signal. When configured for BTSC encoding, the frequency modulator 516 may modulate a carrier of frequency 5 fh by an SAP signal to generate the SAP channel 115 of FIG. 1a. When configured for EIA-J encoding, the frequency modulator 516 may modulate a carrier of frequency 2 fₕ by a difference signal to generate the difference channel 193 of FIG. 1d.

The amplitude modulator 518 may comprise suitable logic circuitry, and/or code for amplitude modulating a carrier tone by a digital audio signal. The amplitude modulator 518 may be configurable via one or more control signals to control, for example, carrier frequency and modulation depth. The amplitude modulator 518 may enable impressing information onto a subcarrier for transmission as part of a multiplexed or composite audio signal. When configured for BTSC encoding, the amplitude modulator 518 may modulate a carrier of frequency 2 fₕ by the output of the spectral and/or amplitude compressor 514 of FIG. 5.

In an exemplary BTSC stereo encoding operation, a “difference” signal (L−R) 507a generated by the subtractor 506 may be routed to filtering and/or scaling block 508 by the switch 502a. The filtering and/or scaling block 508 may perform fixed BTSC preemphasis filtering. The filtered “difference” signal may be conveyed to the amplitude and/or spectral compressor 514. The amplitude and/or spectral compressor 514 may further condition the “difference” signal according to BTSC standards and may convey the “difference” signal to Amplitude modulator 518. The Amplitude modulator 518 may modulate the “difference” signal onto a carrier of frequency 2 fₕ. The switching element 520 may route the “difference” signal to the adder 522. The adder 522 may combine a pilot signal of frequency fₕ and the “difference” signal and output the result to the adder 524. The adder 524 may combine the output of the adder 522 with a “sum” signal (L+R) to generate a BTSC composite audio signal comprising the sum signal 111, the pilot 112 and the difference signal 113 of FIG. 1a. In regards to the “sum” signal, the switch 502b may route the “sum” signal from the adder 504 to the filtering and/or scaling block 510. The filtering and/or scaling block 510 may perform 75 us preemphasis per BTSC stereo standards.

FIG. 6 is a block diagram of an exemplary multi-standard audio encoding block configured for A2 stereo encoding, in accordance with an embodiment of the invention. Referring to FIG. 6, the same multi-standard encoding block 404 of FIG. 4 is shown reconfigured for A2 stereo encoding.

In an exemplary A2 stereo encoding operation, a right audio signal may be routed to filtering and/or scaling block 508 by the switch 502a. The filtering and/or scaling block 508 may perform 50 us preemphasis filtering and/or scaling of the right audio signal in accordance with A2 stereo standards. The adder 522 may combine an identification signal with the right signal to generate the composite audio signal 140 of FIG. 1b. In this regard, the identification signal may comprise a carrier of frequency 3.5 fₕ amplitude modulated by the amplitude modulator 518 by a low frequency flag tone generated by the pilot tone generator 512 in accordance with A2 stereo standards. Additionally, the switch 502b may route a “sum” signal from the adder 504 to the filtering block 510. The filtering block 510 may perform filtering and/or scaling of the “sum” channel per A2 stereo standards to generate the audio channel 130 of FIG. 1. The switch 502a may be configured to route the right or Mono2 signal to the filtering and/or scaling block 508. The switch 502b may be configured to route the Left or Mono1 signal to the filtering and/or scaling block 510. In this regard, mono1 and mono2 signals may be present in dual-sound mode of operation, as shown in Table 1.

FIG. 7 is a block diagram of an exemplary multi-standard audio encoding block configured for EIA-J encoding, in accordance with an embodiment of the invention. Referring to FIG. 7, the same multi-standard encoding block 404 of FIG. 4 is shown reconfigured for EIA-J encoding.

In an exemplary EIA-J stereo encoding operation, a “difference” signal (L−R) generated by the subtractor 506 may be routed to filtering block 508 by the switching element 502a. The filtering and/or scaling block 508 may perform filtering per EIA-J standards, and the filtered and/or scaled “difference” signal may be conveyed to the frequency modulator 516. The frequency modulator 516 may frequency modulate the “difference” signal onto a carrier of frequency 2 fₕ. The adder 522 may combine an identification signal and the frequency modulated “difference” signal and convey the resulting signal to the adder 524. The adder 524 may combine the output of the adder 522 with a “sum” signal (L+R) to generate the EIA-J composite audio signal 190 of FIG. 1d. In regards to the “sum” signal, the switch 502b may route the “sum” from the adder 504 to the filtering and/or scaling block 510. The filtering and/or scaling block 510 may perform preemphasis filtering and/or scaling per EIA-J standards.

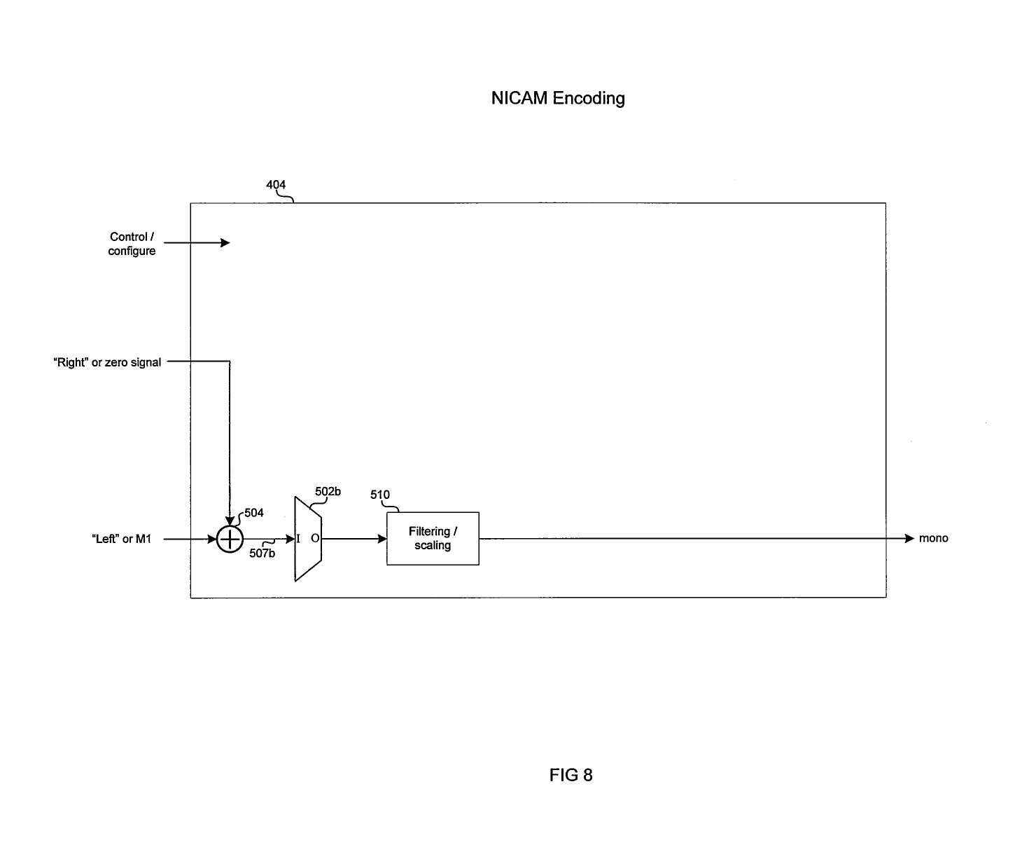

FIG. 8 is a block diagram of an exemplary multi-standard audio encoding block configured for generating a monaural portion of a NICAM composite signal, in accordance with an embodiment of the invention. Referring to FIG. 8, the same multi-standard encoding block 404 of FIG. 4 is shown reconfigured for generating a monaural channel to accompany a NICAM channel in order to maintain compatibility with legacy monaural systems.

In operation, the multi-standard encoding block 404 may generate a monaural audio channel to accompany a NICAM encoded audio channel. In this regard, a “sum” signal may be routed to the filtering and/or scaling block 510 by the switching element 502b. The filtering and/or scaling block 510 may perform filtering and/or scaling per monaural television audio standards and output the monaural channel 150 of FIG. 1c.

In operation, the multi-standard encoding block 404 may generate a monoaural audio channel to accompany a NICAM encoded audio channel for an L audio TV standard. An example of an L audio TV standard may be SECAM-L. In this regard, a “sum” signal may be routed to the filtering and/or scaling block 510 by the switching element 502b. This filtering and/or scaling block 510 may perform filtering and/or scaling per monaural television audio standards and output the monaural channel 150 of FIG. 1c. In such L audio TV standards, the FM/AM modulator 408a of FIG. 4 may be configured to operate as an amplitude modulator. In this regard the block 408a may comprise suitable logic, circuitry, and/or code that may enable it to perform either frequency modulation or amplitude modulation according to the selected standard.

Aspects of a method and system for a multi-standard TV audio encoder are provided. In this regard, an integrated multistandard television audio encoder, such as the audio encoder 308 of FIG. 3, may be configured to encode television audio signals using a specified television audio standard. Moreover, once configured, the multistandard television audio encoder may encode television audio signals using the specified television audio standard. Exemplary television audio standards may comprise BTSC, an exemplary spectrum of which is depicted in FIG. 1a, A2, EIA-J, and NICAM. The multistandard television audio encoder may be enabled to generate all or portions of audio signals, such as depicted in FIGS. 1a, 1b, 1c, and 1d, in accordance with one or more television audio standards. The multistandard television audio encoder may be enabled to generate baseband and/or RF modulated television audio signals. Accordingly, the multistandard television audio encoder may be enabled to generate an audio portion of a composite television signal. The multistandard television audio encoder may be programmably controlled via a processor and/or a control/programming interface, such as the control interface 412 of FIG. 4. Configuration of the multistandard television audio encoder may comprise configuring one or more filters, such as the filtering and/or scaling blocks 508 and 510, to perform preemphasis filtering in accordance with one or more television audio standard. Configuration of the multistandard television audio encoder may comprise configuring one or more modulators, such as the modulators 516 and 518, to perform amplitude and/or frequency modulation of subcarriers in accordance with one or more television audio standard. Configuration of the multistandard television audio encoder may comprise configuring one or more sample rate converters, such as the rate converters 406, to upsample or downsample television audio signals. Aspects of the invention may enable generating one or more pilot and/or identification signals, such as the signals 112, 142, and 195, in accordance with one or more television audio standards.

Another embodiment of the invention may provide a machine-readable storage, having stored thereon, a computer program having at least one code section executable by a machine, thereby causing the machine to perform the steps as described herein for a multi-standard TV audio encoder.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
in an integrated multistandard television audio encoder that is configurable to encode audio signals using a plurality of television audio standards,
configuring said multistandard television audio encoder to encode a television audio signal using a specified one of said plurality of television audio standards; and
encoding, by said multistandard television audio encoder, said television audio signal using said specified one of said plurality of television audio standards based on said configuration.

2. The method according to claim 1, wherein said plurality of television audio standards comprise BTSC, A2, EIA-J, and NICAM.

3. The method according to claim 1, comprising programmably configuring said integrated multistandard television audio encoder to enable said encoding of said television audio signals into one of said plurality of television audio standards.

4. The method according to claim 1, comprising configuring one or more filters within said integrated multistandard television audio encoder to perform preemphasis filtering based on said specified one of said plurality of television audio standards.

5. The method according to claim 1, comprising scaling, via one or more gain circuits within said integrated multistandard television audio encoder, said audio TV signal based on said specified one of said plurality of television audio standards.

6. The method according to claim 1, comprising configuring one or more modulators within said integrated multistandard television audio encoder to perform amplitude modulation, frequency modulation, and/or differential quadrature phase shift keying of subcarriers based on said specified one of said plurality of television audio standards.

7. The method according to claim 1, comprising generating, via one or more pilot generation circuits within said integrated multistandard television audio encoder, one or more pilot and/or identification signals based on said specified one of said plurality of television audio standards

8. The method according to claim 1, comprising configuring one or more sample rate converters within said integrated multistandard television audio encoder to enable rate conversion of said television audio signal.

9. The method according to claim 8, comprising upsampling said television audio signal via said one or more sample rate converters within said integrated multistandard television audio encoder.

10. The method according to claim 8, comprising downsampling said television audio signal via said one or more sample rate converters within said integrated multistandard television audio encoder.

11. The method according to claim 1, comprising generating, via said integrated multistandard television audio encoder, an audio channel portion of a composite television signal.

12. The method according to claim 1, comprising generating, via at least a portion of one or more of said integrated multistandard television audio encoders, baseband and/or RF modulated television audio signals.

13. A system for signal processing, the system comprising:
one or more circuits within an integrated multistandard television audio encoder that is configurable to encode audio signals using a plurality of television audio standards, wherein said one or more circuits enables said multistandard television audio encoder to be configured to encode a television audio signal using a specified one of said plurality of television audio standards; and
said one or more circuits enables said multistandard TV audio encoder to encode said television audio signal using said specified one of said plurality of television audio standards based on said configuration.

14. The system according to claim 13, wherein said plurality of television audio standards comprise BTSC, A2, EIA-J, and NICAM.

15. The system according to claim 13, wherein said one or more circuits enable said integrated multistandard television audio encoder to be programmably configured for said encoding of said encode audio signals into said plurality of television audio standards.

16. The system according to claim 13, wherein said one or more circuits comprises one or more filters enabled to perform preemphasis filtering based on said specified one of said plurality of television audio standards.

17. The system according to claim 13, wherein said one or more circuits comprises one or more gain circuits that enables scaling of said audio TV signal based on said specified one of said plurality of television audio standards.

18. The system according to claim 13, wherein said one or more circuits comprises one or more modulators that enables amplitude modulation and/or frequency modulation and/or differential quadrature phase shift keying of subcarriers based on said specified one of said plurality of television audio standards.

19. The system according to claim 13, wherein said one or more circuits comprises one or more pilot generation circuits that enables generation of one or more pilot and/or identification signals based on said specified one of said plurality of television audio standards

20. The system according to claim 13, wherein said one or more circuits comprises one or more sample rate converters that enables rate conversion of said television audio signal.

21. The system according to claim 20, wherein said one or more circuits upsamples said television audio signal via said one or more sample rate converters within said integrated multistandard television audio encoder.

22. The system according to claim 20, wherein said one or more circuits downsamples said television audio signal via said one or more sample rate converters within said integrated multistandard television audio encoder.

23. The system according to claim 13, wherein said one or more circuits generate an audio channel portion of a composite television signal.

24. The system according to claim 13, wherein said one or more circuits generate baseband and/or RF modulated television audio signals.
